(19) United States
(12) Patent Application Publication
(10) Pub. No.: US 2016/0362316 A1
(43) Pub. Date: Dec. 15, 2016

(54) ADAPTIVE IN-LINE MIXING FOR FLUID FINE TAILINGS FLOCCULATION

(71) Applicant: SYNCRUDE CANADA LTD. in trust for the owners of the Syncrude Project as such owners exist now and, Fort McMurray (CA)

(72) Inventors: BARRY BARA, Edmonton (CA); RANDY MIKULA, Edmonton (CA); JAMES LORENTZ, Fort McMurray (CA)

(21) Appl. No.: 15/171,903

(22) Filed: Jun. 2, 2016

Related U.S. Application Data
(60) Provisional application No. 62/174,344, filed on Jun. 11, 2015.

(51) Int. Cl. C02F 1/52; C02F 1/56

(52) U.S. Cl. CPC C02F 1/5209; C02F 1/56; C02F 1/5263; C02F 2103/10

(57) ABSTRACT

A method for monitoring and controlling flocculation of oil sands fine tailings in a pipeline is provided comprising injecting a polymeric flocculant into a tailings feed being pumped through the pipeline, mixing the polymeric flocculant and tailings feed in the pipeline, and providing one or more adjustable valves in the pipeline that are operable to either reduce the flow area of the adjustable valve to increase shear or dispersed energy when the polymeric flocculant and tailings feed are under-mixed or increase the flow area of the adjustable valve to decrease shear or dispersed energy when the polymeric flocculant and tailings feed are over-mixed.

### CROSS-REFERENCE TO RELATED APPLICATIONS

This application claims priority to U.S. Provisional Patent Application No. 62/174,344, filed Jun. 11, 2015, the entire contents of which is incorporated herein by reference.

### FIELD OF THE INVENTION

The present invention relates generally to a method for monitoring and controlling flocculation of oil sands fine tailings in a pipeline to yield a flocculated material suitable for successful dewatering.

### BACKGROUND OF THE INVENTION

Oil sand ore is mined primarily in the Athabasca Region of Alberta, Canada. Oil sand ores are basically a combination of clay, sand, water and bitumen. Oil sand ores are mined by open pit mining and the bitumen is extracted from the mined oil sand using variations of the Clark Hot Water Process, where water is added to the mined oil sand to produce an oil sand slurry. The oil sand slurry is further processed to separate the bitumen from the rest of the components.

The oil sand extraction process produces both coarse tailings having a general particle size >44 μm and comprising primarily sand, and fine tailings having a general particle size <44 μm and comprising primarily clays. The fine tailings suspension is typically 85% water and 15% fine particles by mass. Such fine tailings are generally referred to as “fluid fine tailings” or “FFT”. “Fluid fine tailings” are a liquid suspension of oil sand fines in water with a solids content greater than 1% and having less than an undrained shear strength of 5 kPa. The fact that fluid fine tailings (FFT) behave as a fluid and have very slow consolidation rates significantly limits options to reclaim tailings ponds.

Dewatering of fine tailings occurs very slowly. When first discharged in ponds, the very low density material is referred to as thin fine tailings. After a few years when the fine tailings have reached a solids content of about 30-35%, they are referred to as mature fine tailings (MFT) which behaves as a fluid-like colloidal material. In general, “mature fine tailings” are fluid fine tailings with a low sand to fines ratio, i.e., less than about 0.3, and a solids content greater than about 30% (nominal). Unfortunately, MFT does not settle very quickly, as the clays essentially remain in suspension. It may take decades for MFT to thicken and dewater. Hence, it is desirable to be able to dewater or solidify FFT or MFT so as to be able to more economically dispose of or reclaim the fine tailings.

A flocculant such as a water-soluble polymer can be added to the oil sands fine tailings to bind the fine clays together (flocculate) to form larger structures (flocs) that can be efficiently separated from the water when ultimately deposited in a deposition area. However, proper mixing of the oil sands tailings and flocculant is required to ensure that the flocculated oil sands tailings exhibit the desired properties for successful dewatering.

Mixing of oil sand tailings and flocculant can occur in a pipeline while tailings are being transported to a designated disposal area (“in-line flow”). “In-line flow” means a flow contained within a continuous fluid transportation line such as a pipe or another fluid transport structure which preferably has an enclosed tubular construction. Mixing of flocculant and tailings during in-line flow is often referred to as “in-line mixing”. Generally, at least one pump is positioned on a pipeline to pump the tailings through the pipeline to the disposal area. The flocculant is added to the pipeline and the flocculant/tailings mixture is sheared as the mixture travels through the pipeline.

In some instances, in-line mixing of flocculant with oil sand tailings can be enhanced by providing one or more in-line mixers in the pipeline. In-line mixers may be static mixers, dynamic mixers, or a combination of both. Dynamic mixers generally have a motor driven mixing device such as an impeller to cause fluid mixing, while static mixers have a stationary baffle or the like and relies on the energy contained within the flowing fluid stream to cause fluid mixing.

There is a need for an effective method of controlling in-line mixing to ensure properly formed flocculated structures when the tailings are deposed for maximum consolidation and dewatering.

### SUMMARY OF THE INVENTION

The present invention relates generally to a method for monitoring and controlling flocculation of oil sands fine tailings in a pipeline to yield a flocculated material suitable for successful dewatering. It was surprisingly discovered that by using the process of the present invention, one or more of the following benefits may be realized:

(1) Proper mixing of the oil sands tailings and flocculant may be readily achieved and monitored in-line to ensure that the flocculated oil sands tailings exhibit the desired properties for successful dewatering. In-line analysis provides faster and better feedback for adjusting process control parameters related to flocculation.

(2) The ability to monitor and control the mixing energy and flocculation of the tailings ensures efficient removal of water from oil sands tailings so that the solids therein can be reclaimed and no longer require residence time in ponds.

(3) The oil sands tailings and flocculant are initially mixed by dispersing the flocculant into the tailings during in-line flow of the tailings by means of an injection device as is known in the art. One or more adjustable valves are situated along the length of the pipeline which are operable to increase or decrease the dispersed energy in the pipeline according to the mixing energy required. Use of adjustable valves decouples the mixing process from the flow rate.

(4) In some embodiments, the tailings and flocculant mixture may be further mixed by means of at least one in-line mixer, such as an in-line static mixer or an in-line dynamic mixer. (5) The operation of the one or more adjustable valves is controlled by a feedback control loop to ensure that there is sufficient mixing energy to maintain optimum characteristics of the flocculated oil sands tailings.

Thus, broadly stated, in one aspect of the present invention, a method for monitoring and controlling flocculation of oil sands tailings in a pipeline is provided, comprising:
pumping a tailings feed having a solids content in the range of about 10 wt % to about 70 wt % through a pipeline;
injecting an effective amount of a polymeric flocculant into the tailings feed to disperse the polymeric flocculant into the tailings feed; and
optimizing mixing of the polymeric flocculant and tailings feed in the pipeline to form flocculated oil sands tailings by adjusting one or more adjustable valves located on the pipeline, the one or more adjustable valve operable to either reduce the flow area of the adjustable valve to increase shear or dispersed energy when the polymeric flocculant and tailings feed are under-mixed or increase the flow area of the adjustable valve to decrease shear or dispersed energy when the polymeric flocculant and tailings feed are over-mixed.

In one embodiment, the polymeric flocculant and tailings feed are introduced into one or more in-line mixers, where the polymeric flocculant and tailings feed are further mixed. In one embodiment, the one or more in-line mixer is one or more in-line static mixers in parallel or in series. In another embodiment, the in-line mixer is one or more in-line dynamic mixers in parallel or in series. In one embodiment, the one or more adjustable valves are located either upstream, downstream, or both, of the one or more in-line mixer. In one embodiment the one or more adjustable valves are adequate to optimize the mixing without the use of one or more static or dynamic mixers in parallel or series.

Additional aspects and advantages of the present invention will be apparent in view of the description, which follows. It should be understood, however, that the detailed description and the specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will now be described by way of an exemplary embodiment with reference to the accompanying simplified, diagrammatic, not-to-scale drawing:

FIG. 1 is a schematic of one embodiment of the present invention for monitoring and controlling the flocculation of oil sands tailings.

FIG. 2 is a schematic of another embodiment of the present invention for monitoring and controlling the flocculation of oil sands tailings.

FIG. 3 is a schematic of another embodiment of the present invention for monitoring and controlling the flocculation of oil sands tailings.

FIG. 4 shows a mixing system where mixing can be automatically controlled using gate valves.

### DETAILED DESCRIPTION OF PREFERRED EMBODIMENTS

The detailed description set forth below in connection with the appended drawings is intended as a description of various embodiments of the present invention and is not intended to represent the only embodiments contemplated by the inventors. The detailed description includes specific details for the purpose of providing a comprehensive understanding of the present invention. However, it will be apparent to those skilled in the art that the present invention may be practised without these specific details.

The present invention relates generally to a method for monitoring and controlling flocculation of oil sands fine tailings in a pipeline. In particular, the method involves in-line mixing of flocculated tailings, such as flocculated oil sand fluid fine tailings, in a pipeline and supplementing the mixing energy by adjusting one or more valves to yield a flocculated material exhibiting the desired properties for successful dewatering.

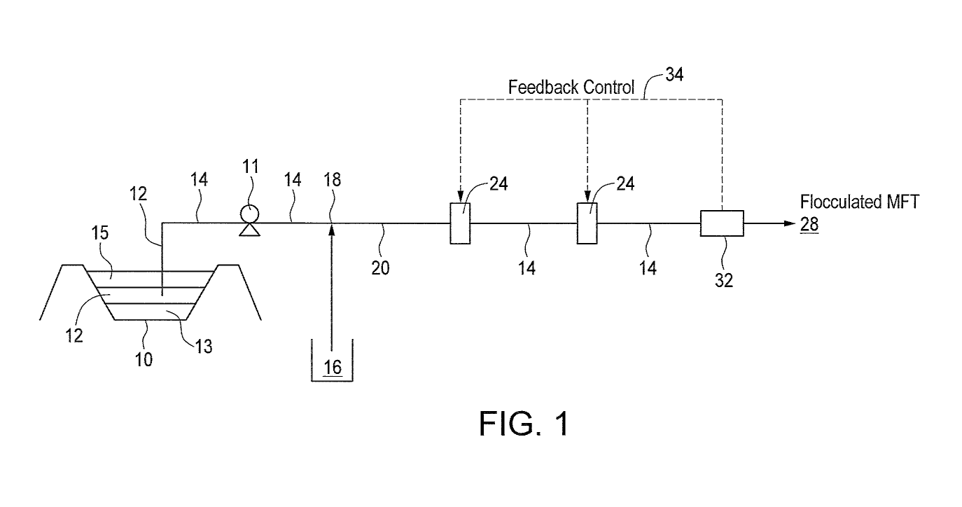

FIG. 1 is a flow diagram of one embodiment of the process of the present invention. As used herein, the term “oil sands tailings” means tailings derived from oil sands extraction operations and containing a fines fraction. The term is meant to include fluid fine tailings (FFT), e.g., mature fine tailings (MFT) from tailings ponds, and fine tailings from ongoing extraction operations (for example, thickener underflow or froth treatment tailings) which may bypass a tailings pond. In the embodiment shown in FIG. 1, oil sands tailings are mature fine tailings (MFT) obtained from a settling basin.

The tailings stream from bitumen extraction is typically transferred to a settling basin 10 where the tailings stream separates into an upper water layer 15, a middle MFT layer 12, and a bottom layer of settled solids 13. The MFT layer 12 is removed from between the water layer and solids layer via a dredge or floating barge having an on board or submersible pump. The MFT will generally have a solids content ranging from about 10 wt % to about 45 wt %. However, any oil sands fine tailings having a solids content ranging from about 10 wt % to about 70 wt % or higher can be used.

The MFT 12 is pumped from the settling basin 10 and then pumped through pipeline 14 via slurry pump 11 (in-line flow). As used herein, the term “in-line flow” means a flow contained within a continuous fluid transportation line such as a pipe or another fluid transport structure which preferably has an enclosed tubular construction.

A flocculating polymer 16 is introduced into the in-line flow of the MFT 12 using, for example, a T-inlet, such that the polymer 16 is dispersed throughout the MFT 12. The MFT 12 and polymer 16 are mixed via shear in the pipeline 14 itself. In one embodiment, the polymer 16 is injected into pipeline 14 at a polymer injection zone 18. The polymer 16 is injected as a jet using a polymer injector (not shown). Suitable polymer injectors for use in injecting the polymer 16 are known in the art including, but not limited to, a venturi-type injector, a nozzle-type injector, and the like.

As used herein, the term “flocculating polymer” refers to a flocculant or reagent which bridges the neutralized or coagulated particles into flocs, resulting in more efficient settling. As used herein, “flocs” are larger-size clusters of mineral particles produced as a result of flocculation. “Flocculation” is a process of contact and adhesion of mineral particles due to the addition of a flocculant, a coagulant or a combination of a flocculant and coagulant. Flocculants useful in the present invention are generally anionic, nonionic, cationic or amphoteric polymers, which may be naturally occurring or synthetic, having relatively high molecular weights. Preferably, the polymeric flocculants are characterized by molecular weights ranging between about 1,000 kD to about 50,000 kD. Suitable natural polymeric flocculants may be polysaccharides such as dextran, starch or guar gum. Suitable synthetic polymeric flocculants include, but are not limited to, charged or uncharged polyacrylamides, for example, a high molecular weight polyacrylamide-sodium polyacrylate co-polymer with about 25-35% anionicity.

Other useful polymeric flocculants can be made by the polymerization of (meth)acryamide, N-vinyl pyrrolidone, N-vinyl formamide, N,N dimethylacrylamide, N-vinyl acetamide, N-vinylpyridine, N-vinylimidazole, isopropyl acrylamide and polyethylene glycol methacrylate, and one or more anionic monomer(s) such as acrylic acid, methacrylic acid, 2-acrylamido-2-methylpropane sulphonic acid (ATBS) and salts thereof, or one or more cationic monomer(s) such as dimethylaminoethyl acrylate (ADAME), dimethylaminoethyl methacrylate (MADAME), dimethydiallylammonium chloride (DADMAC), acrylamido propyltrimethyl ammonium chloride (APTAC) and/or methacrylamido propyltrimethyl ammonium chloride (MAPTAC). The preferred flocculant may be selected according to the oil sand tailings composition and process conditions.

The flocculant is generally supplied from a flocculant make up system for preparing, hydrating and dosing of the flocculant. Flocculant make-up systems are well known in the art, and typically include a polymer preparation skid, one or more storage tanks, and a dosing pump. The dosage of flocculant may be controlled by a metering pump.

Once the polymer 16 is dispersed into the MFT 12, the MFT 12 and polymer 16 continue to mix while travelling through the pipeline 14 (MFT/polymer mixture 20). The dispersed fine clays begin to bind together or flocculate to form flocs.

Proper mixing of the MFT/polymer mixture 20 is required to create fairly well defined floc structures which results in good dewatering. However, due to variations in feed composition, flow rate, etc., there are situations where additional mixing may be necessary to obtain flocculated MFT that is readily dewatered. Proper (i.e., optimum) mixing of the MFT 12 and polymer 16 may be monitored in-line by various process monitors 32 to ensure that the flocculated tailings 28 exhibit the desired properties for successful dewatering.

Under-mixing results in poor floc formation thereby preventing the efficient separation of the fines from the water (dewatering). Over-mixing can cause the flocs to be irreversibly broken down, resulting in resuspension of the fines in the water thereby preventing water release and drying. Parameters which may be monitored include static mixer pressure, pipeline pressure, visual floc structure, and the like. Methods of monitoring include optical probes for particle vision and measurement, and pressure sensors for measuring in-line mixer pressure and pipeline pressure. In-line monitoring provides direct real-time observation of key mechanisms in-process and removes the need for off-line analysis and sampling, and eliminates the time-delay associated with off-line analysis. Measuring in-line provides faster process understanding and optimization to improve yield and product quality.

To ensure optimal mixing of the flocculant and tailings, in this embodiment, at least one adjustable valve 24 is mounted to pipeline 14 downstream of the flocculant injection site 18. As shown in FIG. 1, two adjustable valves have been added to the pipeline 14. The adjustable valves 24 are operable to incrementally reduce the flow area therethrough, thereby causing an increased pressure drop across the valve. This, in turn, causes increased shear or dispersed energy to be imparted to the MFT/polymer mixture 20 and, thus, providing additional mixing of the flocculated tailings 28.

The flow area of each adjustable valve 24 may be controlled to ensure that there is sufficient mixing energy to maintain optimum characteristics of the flocculated MFT 28. Feedback loop control 34 of the valves 24 is used to maintain the mixing energy at a pre-determined level or within a pre-set range. The presence of one or more adjustable valves 24 decouples the mixing process from the flow rate.

When the flocculated tailings 28 are sufficiently mixed, as determined by process monitor 32, the feedback control 34 will signal either one or both of the adjustable valves 24 to be held at their current position. Thus, additional shearing by the valves 24 of the MFT/polymer mixture 20 through pipeline 14 does not occur. The flocculated tailings 28 can then be transferred to a centrifuge, filter, settler, and the like, or to a designated tailings disposal site. For example, the flocculated tailings 28 can be further treated by centrifugation to dewater the oil sands fine tailings and form a high solids cake and a low solids centrate; added to a thickener to dewater the oil sands fine tailings and produce thickened oil sands fine tailings and clarified water; directly deposited in thin sloping layers (thin-lift); subjected to accelerated dewatering (rim ditching); or deposited into other tailings deposition cells.

However, if the process monitor detects incomplete mixing, e.g., poor quality flocculated tailings 28, the feedback control 34 provides a signal to either one or both of the adjustable valves 24 that the valve should be partially closed to reduce the flow area and increase the pressure drop across the valve. Hence, increased shear or dispersed energy will be imparted to the MFT/polymer mixture 20 to achieve the pre-set level of mixing energy.

The valve 24 may comprise any suitable valve employed by those skilled in the art to restrict the flow of MFT/polymer mixture 20 through pipeline 14 and thereby increasing the shearing of the MFT/polymer mixture 20. Examples of suitable valves include, but are not limited to, gate valves, such as a knife gate valve, a ball valve, and the like. In one embodiment, the adjustable valve 24 is a gate valve. The adjustable valve 24 may be adjusted manually or automatically using hydraulic, pneumatic or electrical actuators attached thereto.

Pressure sensors (not shown) may be distributed along the pipeline 14 for collecting pressure data over a specific time period. In one embodiment, at least one pressure sensor may be used to measure pressure drop in pipeline 14. The proper pressure reading or a combination of pressure readings in pipeline 14 indicates well-flocculated tailings.

The pressure sensor is mounted on the pipe to detect pipeline pressure, and is operatively connected to a controller. The pressure sensor generates signals representative of the pressure, and transmits the signals to the controller. The signals generated from the pressure sensor are acquired in real time and immediately transmitted to the controller.

The controller may be a separate unit or integrated with a computer comprising any desktop computer, laptop computer, a handheld or tablet computer, or a personal digital assistant, and is programmed with appropriate software, firmware, a microcontroller, a microprocessor or a plurality of microprocessors, a digital signal processor or other hardware or combination of hardware and software known to those skilled in the art. The computer may be located within a company, possibly connected to a local area network, and connected to the Internet or to another wide area network, or connected to the Internet or other network through a large application service provider. The application software may comprise a program running on the computer, a web service, a web plug-in, or any software running on a specialized device, to enable the images to be processed and analyzed. The controller provides a user interface for monitoring and controlling the flocculation of the oil sands tailings. Thus, the sensor (e.g., a pressure sensor) sends a signal to an actuator which strokes the valve.

Images of the flocculated tailings 28 may be used in conjunction with pressure sensors to monitor and control flocculation of the MFT/polymer mixture 20. In one embodiment, an image capture device may be positioned in the flow of the MFT/polymer mixture 20 through pipeline 14 situated downstream of valve 24 in order to allow for the acquisition of one or more images for determining the degree of flocculation of the tailings 28. The images of the flocculated tailings 28 are analyzed to ensure production of optimum floc structures for maximum dewatering. The degree of flocculation is calculated from the images. Suitable image capture devices include, but are not limited to, a particle vision and measurement probe, and the like. The image capture device is operatively connected to the computer. The image capture probe acquires images of the flocculated tailings 28 and transmits signals representative of the images to the computer. The images from the image capture device are acquired in real time and immediately transmitted to the controller.

If the criteria for the pressure and/or image signals deviate from predetermined levels or pre-set ranges, an alarm can be subsequently activated to alert the operator to take recovery action. Recovery may involve adjusting various process parameters including, but not limited to, the mixing energy, flocculant dosage, and the like. The operator may visually assess the flocculated tailings 28 from the images and/or review pipeline pressure data to re-establish normal operations. The images and pressure data may be collected easily and rapidly from the pipeline for processing, analysis and integration into any suitable control narrative.

Thus, in the embodiment described above, in some instances it is important to have a first step comprising dispersion of the flocculant polymer 16 into the MFT 12, followed by a second step of supplementing mixing energy to promote floc growth by partially closing one or more valves 24. A well-dispersed MFT/polymer mixture 20 flowing through pipeline 14 develops increasingly large flocs suitable for dewatering. Additionally, the ability to monitor and control the mixing energy and flocculation of the tailings ensures efficient removal of water from oil sands tailings so that the solids therein can be reclaimed and no longer require residence time in ponds.

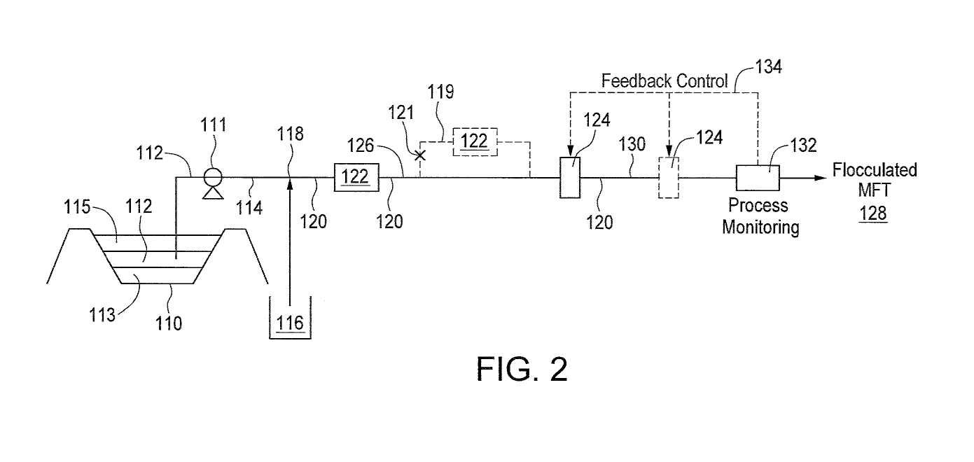

FIG. 2 is another embodiment of the present invention. In this embodiment, the tailings stream from bitumen extraction is transferred to a settling basin 110 where the tailings stream separates into an upper water layer 115, a middle MFT layer 112, and a bottom layer of settled solids 113. The MFT layer 112 is removed from between the water layer and solids layer via a dredge or floating barge having an on board or submersible pump. The MFT will generally have a solids content ranging from about 10 wt % to about 45 wt %. However, any oil sands fine tailings having a solids content ranging from about 10 wt % to about 70 wt % or higher can be used.

The MFT 112 is pumped from the settling basin 110 and then pumped through pipeline 114 via slurry pump 111 (in-line flow). A flocculating polymer 116 is introduced into the in-line flow of the MFT 112 using, for example, a T-inlet, such that the polymer 116 is dispersed throughout the MFT 112. The MFT 112 and polymer 116 are mixed via shear in the pipeline 114 itself. In one embodiment, the polymer 116 is injected into pipeline 114 at a polymer injection zone 118. The polymer 116 is injected as a jet using a polymer injector (not shown).

Once the polymer 116 is dispersed into the MFT 112, the MFT 112 and polymer 116 continue to mix while travelling through the pipeline 114. The dispersed fine clays begin to bind together or flocculate to form flocs. In this embodiment, the MFT/polymer mixture 120 passes through an in-line mixer 122 to continue mixing the MFT and polymer and enhance floc formation. It is understood, however, that more than one in-line mixer can be used. The in-line mixers can be used in series, as shown in FIG. 2, or in parallel. A shut-off valve 121 can be inserted in pipeline 119 so that the operator has the option of using either one or multiple in-line mixers.

In one embodiment, in-line mixer 122 can be an in-line static mixer. As used herein, the term “in-line static mixer” means a motionless mixer which is inserted into a housing or pipeline with the objective of manipulating fluid streams, in this instance, to significantly accelerate the in-line reaction of flocculation. Typical designs of in-line static mixers comprise plates, baffles, helical elements or geometric grids positioned at precise angles to direct flow and increase turbulence. Suitable in-line static mixers for use in the present invention are known in the art. In another embodiment, the in-line mixer is an in-line dynamic mixer. As used herein, the term “in-line dynamic mixer” means a mixer generally comprising an impeller such as a radical flow turbine or a pitched blade turbine, which has high shear performance characteristics. Suitable in-line dynamic mixers are known in the art.

Proper mixing of the MFT/polymer mixture 120 is required to create fairly well defined floc structures which results in good dewatering. However, due to variations in feed composition, flow rate, etc., there are situations where additional mixing may be necessary to obtain flocculated MFT that is readily dewatered. Proper (i.e., optimum) mixing of the MFT 112 and polymer 116 may be monitored in-line by various process monitors 132 to ensure that the flocculated tailings 128 exhibit the desired properties for successful dewatering.

Pressure sensors (not shown) may thus be positioned in the in-line mixer 122 and/or distributed along the pipelines 126, 130 for collecting pressure data over a specific time period. In one embodiment, at least one pressure sensor may be used to measure pressure drop across the in-line mixer 122. In one embodiment, at least one pressure sensor may be mounted to pipeline 126 situated downstream of in-line mixer 122 for measuring pressure drop in pipeline 126. In one embodiment, at least one pressure sensor may be mounted to pipeline 130 situated downstream of the valve 124 for measuring pressure drop in pipeline 130. The proper pressure reading or combination of pressure readings indicates well-flocculated tailings.

The pressure sensor is mounted on the pipe to detect pipeline pressure, and is operatively connected to a controller. The pressure sensor generates signals representative of the pressure, and transmits the signals to the controller. The signals generated from the pressure sensor are acquired in real time and immediately transmitted to the controller, which then in turn sends a signal to the pump motor actuator for more or less pressure or to at least one valve for more or less mixing.

Images of the flocculated tailings 128 may be used in conjunction with pressure to monitor and control flocculation of the tailings 128. In one embodiment, an image capture device may be positioned in the flow of flocculated tailings 128 through pipeline 126 situated downstream of in-line mixer 122, and/or through pipeline 130 situated downstream of valve 124 in order to allow for the acquisition of one or more images for determining the degree of flocculation of the flocculated tailings 128. The images of the flocculated tailings 128 are analyzed to ensure production of optimum floc structures for maximum dewatering. The degree of flocculation is calculated from the images. Suitable image capture devices include, but are not limited to, a particle vision and measurement probe, and the like. The image capture device is operatively connected to the controller. The image capture probe acquires images of the flocculated tailings 128 and transmits signals representative of the images to the controller. The images from the image capture device are acquired in real time and immediately transmitted to the controller.

If the criteria for the pressure and/or image signals deviate from predetermined levels or pre-set ranges, an alarm can be subsequently activated to alert the operator to take recovery action. Recovery may involve adjusting various process parameters including, but not limited to, the mixing energy, flocculant dosage, and the like. The operator may visually assess the flocculated tailings 128 from the images and/or review pipeline pressure data to re-establish normal operations. The images and pressure data may be collected easily and rapidly from the pipeline for processing, analysis and integration into any suitable control narrative.

Thus, in the embodiment described above, in some instances it is important to have a first step comprising dispersion of the flocculant polymer 116 into the MFT 112, followed by further mixing in in-line mixer 122, and further followed by a second step of supplementing mixing energy to promote floc growth by partially closing one or more valves 124. A well-dispersed MFT/polymer mixture 120 flowing through pipelines 126 and 130 develops increasingly large flocs suitable for dewatering. Additionally, the ability to monitor and control the mixing energy and flocculation of the tailings ensures efficient removal of water from oil sands tailings so that the solids therein can be reclaimed and no longer require residence time in ponds.

The flow area of each adjustable valve 124 may be controlled to ensure that there is sufficient mixing energy to maintain optimum characteristics of the flocculated MFT 128. Feedback control loop 134 of the valves 124 is used to maintain the mixing energy at a pre-determined level or within a pre-set range. The presence of one or more adjustable valves 124 decouples the mixing process from the flow rate.

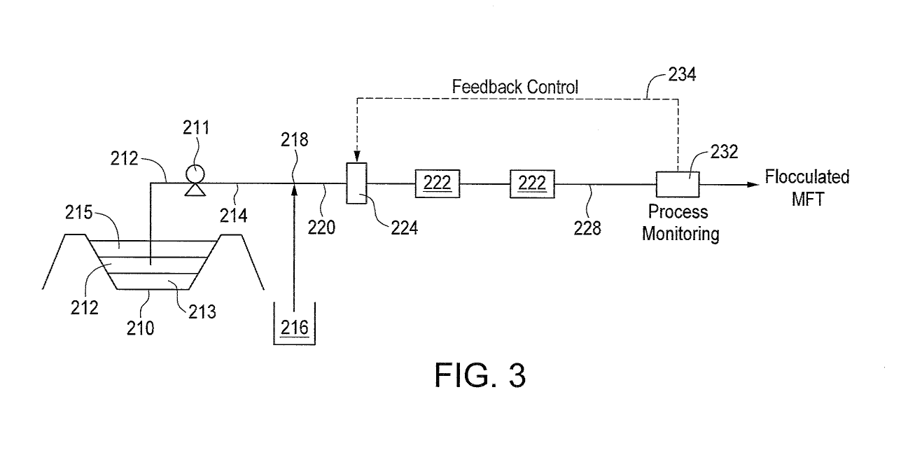

FIG. 3 is a flow diagram of another embodiment of the process of the present invention. In this embodiment, settling basin 210 has an upper water layer 215, a middle MFT layer 212, and a bottom layer of settled solids 213. The MFT layer 212 is removed from between the water layer and solids layer via a dredge or floating barge having an on board or submersible pump and travels through pipeline 214. Polymer 216 is injected into pipeline 214 at a polymer injection zone 218. The polymer 216 is injected as a jet using a polymer injector (not shown). Polymer 216 and MFT 212 continue to mix while travelling through the pipeline 214. The dispersed fine clays begin to bind together or flocculate to form flocs. The MFT/polymer mixture 220 then passes through in-line mixer 222 to continue mixing the MFT and polymer and enhance floc formation. It is understood that more than one in-line mixer can be used. The in-line mixer can be an in-line static mixer, an in-line dynamic mixer, or a combination of both.

Process monitor 232 is operable to detect incomplete mixing, e.g., poor quality flocculated tailings 228. However, in this embodiment, the feedback control 234 provides a signal to adjustable valve 224, which is positioned upstream of the in-line mixer 222. Thus, the polymer 216 and MFT 212 are pre-mixed before further mixing in in-line mixer 222. Thus, if incomplete mixing is detected by process monitor 232, the feedback control 234 will partially close adjustable valve 224 to reduce the flow area and increase the pressure drop across the valve. Hence, increased shear will be imparted to the flocculated tailings 228 prior to further mixing in the in-line mixer 222.

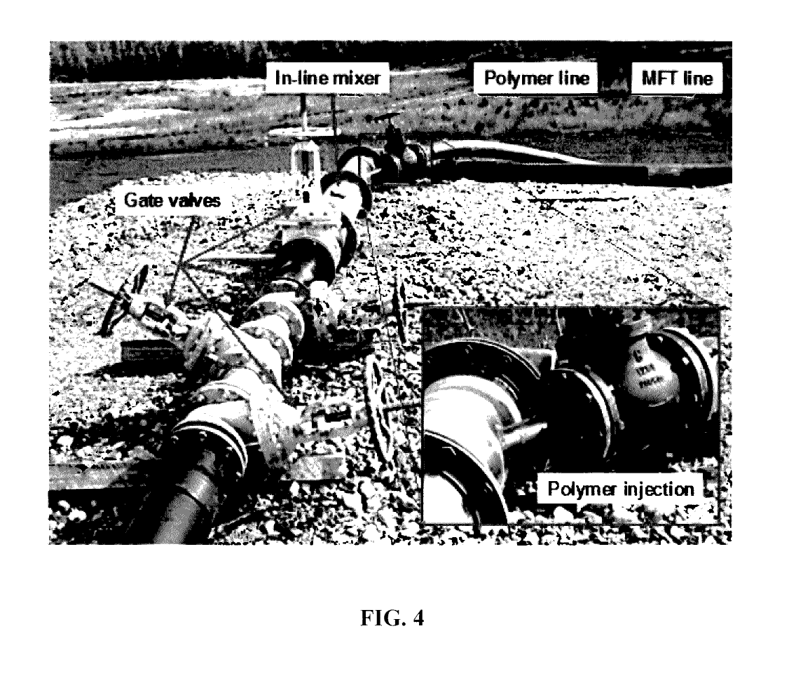

FIG. 4 shows a mixing system useful in the present invention. Tailings (MFT) line and polymer line meet at polymer injection site and the polymer and MFT are further mixed in an in-line mixer (e.g., an in-line static mixer). Three gate valves are spatially positioned along a transport pipeline, each gate valve adjustable to control the flow of tailings therethrough.

From the foregoing description, one skilled in the art can easily ascertain the essential characteristics of this invention, and without departing from the spirit and scope thereof, can make various changes and modifications of the invention to adapt it to various usages and conditions. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims.

We claim:

1. A method for monitoring and controlling flocculation of oil sands fine tailings in a pipeline, comprising:
a) pumping a tailings feed having a solids content in the range of about 10 wt % to about 70 wt % through a pipeline;
b) injecting an effective amount of a polymeric flocculant into the tailings feed to disperse the polymeric flocculant into the tailings feed; and
c) optimizing mixing of the polymeric flocculant and tailings feed in the pipeline to form flocculated oil sands tailings by adjusting one or more adjustable valves located on the pipeline, said one or more adjustable valves operable to either reduce the flow area of the adjustable valve to increase shear or dispersed energy when the polymeric flocculant and tailings feed are under-mixed or increase the flow area of the adjustable valve to decrease shear or dispersed energy when the polymeric flocculant and tailings feed are over-mixed.

2. The method as claimed in claim 1, further comprising introducing the polymeric flocculant and tailings feed into one or more in-line mixers located on the pipeline for further mixing.

3. The method as claimed in claim 2, wherein the one or more in-line mixer is one or more in-line static mixers in parallel or in series.

4. The method as claimed in claim 2, wherein the one or more in-line mixer is one or more in-line dynamic mixers in parallel or in series.

5. The method as claimed in claim 2, wherein the one or more adjustable valves are located either upstream, downstream, or both, of the one or more in-line mixer.

6. The method as claimed in claim 1, wherein under-mixing and/or over-mixing of the polymeric flocculant and tailings feed is monitored by at least one process monitor.

7. The method as claimed in claim 6, wherein the at least one process monitor is located in the pipeline.

8. The method of claim 1, further comprising positioning at least one pressure sensor on the pipeline for collecting pressure data over a specific time period.

9. The method of claim 2, further comprising positioning at least one pressure sensor in the in-line mixer for collecting pressure data over a specific time period.

10. The method of claim 8, wherein the pressure sensor is capable of detecting pressure of the flocculated oil sands tailings during operation of the pipeline and outputting and transmitting corresponding pressure signals to a controller.

11. The method of claim 8, further comprising positioning an image capture device in the flow of flocculated oil sands tailings through the pipeline for acquiring one or more images of the flocculated oil sands tailings; and transmitting the one or more images to a computer for analysis to ensure production of optimum floc structures for maximum oil sands fine tailings dewatering.

12. The method of claim 11, wherein the pressure sensor and image capture device are operatively connected to a controller, the controller being configured to incorporate processed and analyzed pressure signals from the pressure sensor, and processed and analysed image data into its control narrative.

13. The method of claim 12, further comprising activating an alert upon determination that the pressure signals, the image signals, or both deviate from predetermined levels or pre-set ranges.

14. The method of claim 1, wherein the flocculated oil sands tailings are further treated in at least one centrifuge or at least one thickener or both for further separation of the release water from the tailings flocs.

15. The method of claim 1, wherein the flocculated oil sands tailings are deposited in a deposition site for spreading as a thin layer onto the site.

16. The method of claim 1, wherein the flocculated oil sands tailings are deposited in at least one deposition cell such as an accelerated dewatering cell for dewatering.

17. The method of claim 1, wherein the polymeric flocculant comprises a high molecular weight nonionic, anionic, or cationic polymer.

18. The method of claim 1, wherein the flocculant is a charged or uncharged polyacrylamide.

19. The method of claim 1, wherein the flocculant is a high molecular weight polyacrylamide-sodium polyacrylate co-polymer with about 25-35% anionicity.

20. The method of claim 1, wherein the flocculant has a molecular weight ranging between about 1,000 kD to about 50,000 kD.

21. The method of claim 1, wherein the flocculant is a polysaccharide such as dextran, starch or guar gum.

22. The method of claim 1, wherein the polymeric flocculant is made by the polymerization of (meth)acryamide, N-vinyl pyrrolidone, N-vinyl formamide, N,N dimethylacrylamide, N-vinyl acetamide, N-vinylpyridine, N-vinylimidazole, isopropyl acrylamide and polyethylene glycol methacrylate, and one or more anionic monomer(s) such as acrylic acid, methacrylic acid, 2-acrylamido-2-methylpropane sulphonic acid (ATBS) and salts thereof, or one or more cationic monomer(s) such as dimethylaminoethyl acrylate (ADAME), dimethylaminoethyl methacrylate (MADAME), dimethydiallylammonium chloride (DADMAC), acrylamido propyltrimethyl ammonium chloride (APTAC) and/or methacrylamido propyltrimethyl ammonium chloride (MAPTAC).

23. The method as claimed in claim 1, wherein the tailings are mature fine tailings having a solids content of about 10% to about 45%.

24. The method of claim 1, wherein the one or more adjustable valves comprises a gate valve.
